(19) United States
(12) Patent Application Publication
(10) Pub. No.: US 2023/0007936 A1
(43) Pub. Date: Jan. 12, 2023

(54) INJECTOR APPARATUS

(71) Applicant: RKLAB AG, Root D4 (CH)

(72) Inventors: Daniel EASTWOOD, Shoreham-by-Sea West Sussex (GB); Riccardo MELDOLESI, Shoreham-by-Sea West Sussex (GB); Martin SELWAY, Shoreham-by-Sea West Sussex (GB); John LUTWYCHE, Shoreham-by-Sea West Sussex (GB)

(73) Assignee: RKLAB AG, Root D4 (CH)

(21) Appl. No.: 17/783,284

(22) PCT Filed: Dec. 9, 2020
(86) PCT No.: PCT/EP2020/085356

§ 371 Date: Jun. 8, 2022

(30) Foreign Application Priority Data
Dec. 9, 2019 (GB) 1918011.6

(51) Int. Cl. F02M 47/02; F02M 55/00; F02M 61/10

(52) U.S. Cl. CPC F02M 47/025; F02M 55/007; F02M 61/10; F02M 2200/40

(57) ABSTRACT

An injector apparatus (210) for injecting fluid under pressure into an associated chamber (232) is provided. The injector apparatus (210) includes a first piston (214) defining a first working area facing an associated chamber, and a high pressure piston (218) defining a high pressure working area facing a high pressure chamber. The first working area is greater than the high pressure working area and the first piston is moveable in a body of the injector apparatus (210) to compress fluid in the high pressure chamber using the high pressure piston. The injector apparatus (210) further includes an accumulator (270) operable to supply fluid under pressure through an injector orifice (276) into an associated chamber (232), the high pressure chamber being operable to pressurise the accumulator (270) with fluid.

The present invention relates to an injector apparatus for injecting fluid under pressure into an associated chamber, to internal combustion engines comprising such injector apparatuses, and to an injector system comprising first and second injector apparatuses for injecting fluid under pressure into an associated chamber.

Although the present invention is described with reference to fuel injectors used in internal combustion engines, it is applicable to any injector apparatus for injecting a fluid under pressure into an associated chamber.

Fuel injectors used in internal combustion engines, including both spark ignition and compression ignition (or diesel) engines, generally utilise an external pump for supplying the fuel under sufficient pressure to be injected into the engine cylinder. The timing of the injection point in the engine operating cycle is determined by external controlling of the operation of an injector valve by a mechanical or electrical means. One disadvantage of providing external pumping and the control is the need for the provision of servicing of such external systems.

According to a first aspect of the present invention, there is provided an injector apparatus for injecting fluid under pressure into an associated chamber, the apparatus including a body, a first piston moveable in the body, the first piston defining a first working area facing an associated chamber, a high pressure piston defining a high pressure working area facing a high pressure chamber, the first working area being greater than the high pressure working area, the first piston being operable to compress fluid in the high pressure chamber using the high pressure piston, the injector apparatus further including an accumulator, the high pressure chamber being operable to pressurise the accumulator with fluid and the accumulator being operable to supply fluid under pressure through an injector orifice into an associated chamber.

With this arrangement, the injector apparatus is operable to generate very high injection pressures using the pressure within the combustion chamber without the need for an external high pressure pump. Further, by providing an accumulator which is pressurised with fluid by the high pressure chamber and is operable to supply fluid under pressure through the injector orifice, the available injection pressure for the next engine cycle is increased. This allows greater flexibility in deciding the optimal injection timing while maintaining maximum potential injection pressure. The accumulator provides the freedom to adjust injection timing whilst maintaining an injection pressure which would not otherwise be achievable. The accumulator also serves to damp out the highly dynamic changes in fluid pressure that might otherwise be seen in the injector.

The injector apparatus may further comprise one or more check valves located between the accumulator and the high pressure chamber.

The one or more check valves may be configured to allow fluid flow in a first direction from the high pressure chamber to the accumulator and to restrict or prevent fluid flow in a second direction from the accumulator to the high pressure chamber.

The accumulator may be located downstream of the high pressure chamber and upstream of the injector orifice.

The injector apparatus may further comprise a refill port by which the high pressure chamber is refilled with fluid during operation. The accumulator may be located downstream of the refill port and upstream of the injector orifice.

The accumulator may have a maximum volume of from 7 to 700 times the maximum volume of the high pressure chamber. The accumulator may have a maximum volume of from 10 to 100 times the maximum volume of the high pressure chamber. The accumulator may have a maximum volume of from 20 to 30 times the maximum volume of the high pressure chamber.

The accumulator may have a maximum volume of from 2 to 20 cc. The accumulator may have a maximum volume of from 5 to 10 cc.

The accumulator may comprise one or more moveable components by which the volume of the accumulator may be varied. The volume of the accumulator may be constant.

The injector apparatus may further comprise a control chamber, wherein movement of the first piston is selectively controllable by controlling the fluid in the control chamber. The

T The injector apparatus may further comprise a valve seat and a valve member selectively operable to engage the valve seat to operably isolate the high pressure chamber from the injector orifice and selectively operable to disengage the valve seat to fluidly connect the high pressure chamber with the injector orifice.

The control chamber may be partially defined by the valve member.

The injector apparatus may further comprise a control chamber vent valve operable to vent the control chamber to a low pressure region.

The injector apparatus may be configured so that operating the control chamber vent valve to vent the control chamber to a low pressure region allows the valve member to disengage the valve seat.

The control chamber may be fluidly coupled with the accumulator.

The injector apparatus may further comprise a restrictor having a restrictor orifice by which the control chamber is fluidly coupled with the accumulator.

The restrictor orifice may be configured to generate a pressure differential between the control chamber and the accumulator when the control chamber vent valve is operated to vent the control chamber to a low pressure region.

The lower pressure region may be a tank or reservoir. The lower pressure region may be configured to store fluid to be injected. The lower pressure region may contain fluid to be injected. The lower pressure region may be open to the atmosphere.

The accumulator may have a maximum volume of from 400 to 4000 times the maximum volume of the control chamber. The accumulator may have a maximum volume of from 1000 to 2000 times the maximum volume of the control chamber. The accumulator may have a maximum volume of from 1200 to 1600 times the maximum volume of the control chamber.

The injector apparatus may further comprise a nozzle chamber directly upstream of the injector orifice, wherein the accumulator is operable to supply fluid under pressure through the injector orifice via the nozzle chamber.

The accumulator may have a maximum volume of from 2 to 20 times the maximum volume of the nozzle chamber. The accumulator may have a maximum volume of from 5 to 10 times the maximum volume of the nozzle chamber.

The accumulator may comprise an accumulator chamber defined within the body of the injector.

The accumulator chamber may be concentric with the injector orifice. The accumulator chamber may be offset from a central axis of the injector orifice.

The accumulator may be external to the body of the injector.

The accumulator may be operable to supply fluid under pressure through the injector orifice of the injector apparatus into an associated chamber of the injector apparatus.

The accumulator may be operable to supply fluid under pressure through an injector orifice of a further injector apparatus into an associated chamber of the further injector apparatus.

The high pressure piston may be annular.

The first piston may be concentric with the high pressure piston.

The first piston may comprise the high pressure piston. The piston may be unitary with the high pressure piston.

The first piston may be distinct from the high pressure piston. The first piston may be distinct from the high pressure piston and connected to it by one or more intermediate elements.

The high pressure piston may be cylindrical.

The first piston may define a high pressure bore of the high pressure chamber within which the high pressure piston is positioned.

The high pressure piston may be fixed relative to the body.

The high pressure piston may be moveable relative to the body.

The injector apparatus may further include a low pressure chamber at least partially defined by the first piston and a bore of the body and configured to displace fluid to a low pressure region during injection.

The control chamber may be fluidly connected to the low pressure chamber via a first passage in which a control chamber vent valve is located, the control chamber vent valve being operable to vent the control chamber to the low pressure chamber. For example, the control chamber vent valve may be operable to vent the control chamber to the low pressure chamber in order to initiate fluid injection.

The high pressure chamber may be fluidly connected to the low pressure chamber via a second passage in which an inlet check valve is located, the inlet check valve being configured to permit the supply of fluid to the high pressure chamber from the low pressure chamber via the second passage.

The low pressure chamber may be at least partly defined by an annular bore of the first piston. The low pressure chamber may be at least partly defined by an annular bore in the body of the injector apparatus. The low pressure chamber may be defined by an annular bore of the first piston and by an annular bore in the body of the injector apparatus which are fluidly connected to together define the low pressure chamber.

The injector apparatus may further include a pump operable to supply fluid to the high pressure chamber along a feed line. The pump may be operable to supply fluid from a low pressure region prior to injection.

The injector apparatus may further include a pressure relief valve between the feed line and a low pressure region. The pressure relief valve may be configured to close when the fluid pressure in the feed line is at or below a threshold value. The pressure relief valve may be configured to open to vent fluid from the feed line to the low pressure region when the fluid pressure in the feed line exceeds the threshold value.

The first piston may include the injector orifice through which fluid can be injected into an associated chamber. In other examples, the injector orifice may be provided as part of one or more other components of the injector apparatus. For example, the injector orifice may be provided as part of an injector nozzle forming part of the injector apparatus. The injector nozzle may be connected to the first piston. The injector nozzle may extend through a bore in an end wall of the first piston.

The first piston may be freely moveable relative to the body. In such embodiments, the first piston is moved towards and away from the associated chamber during use due to pressure imbalances above and below the first piston. Alternatively, the injector apparatus may further comprise a return spring configured to bias the first piston towards the associated chamber during use. In this manner, it can be possible to supply the injector apparatus with fluid even when the pressure in the combustion chamber is higher than on the opposite side of the first piston. This can provide greater flexibility in the amount and timing of a flow of low pressure fluid into the injector apparatus for cooling during operation.

According to a second aspect of the invention, there is provided an injector system comprising a first injector apparatus for injecting fluid under pressure into an associated chamber; and a second injector apparatus for injecting fluid under pressure into an associated chamber, wherein each injector apparatus comprises: a body; a first piston moveable in the body, the first piston defining a first working area facing an associated chamber; a high pressure piston defining a high pressure working area facing a high pressure chamber, the first working area being greater than the high pressure working area, the first piston being operable to compress fluid in the high pressure chamber using the high pressure piston; and an injector orifice. The injector system further comprises an accumulator which is common to both of the first and second injector apparatuses, the high pressure chamber of each of first and second injector apparatuses being operable to pressurise the accumulator with fluid. The accumulator is operable to supply fluid under pressure through the injector orifice of the first injector apparatus and through the injector orifice of the second injector apparatus.

According to a third aspect of the invention, there is provided a reciprocating internal combustion engine comprising at least one combustion chamber, and at least one injector apparatus according to the first aspect, the at least one injector apparatus being configured to inject fluid under pressure into the at least one combustion chamber.

The invention will now be described, by way of example only, with reference to the accompanying drawings, in which:

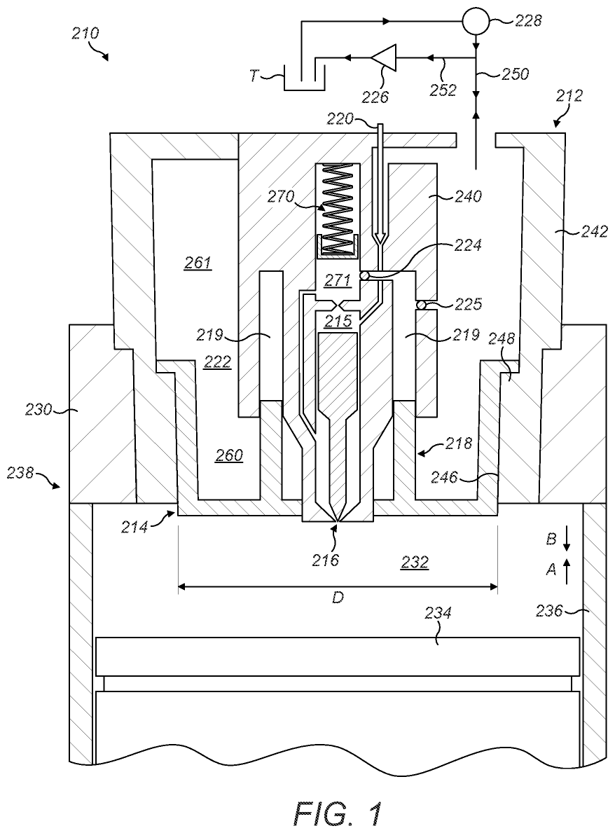

FIG. 1 is a cross-section view of first embodiment of injector apparatus according to the present invention showing the injector apparatus received in a cylinder head of a reciprocating internal combustion engine;

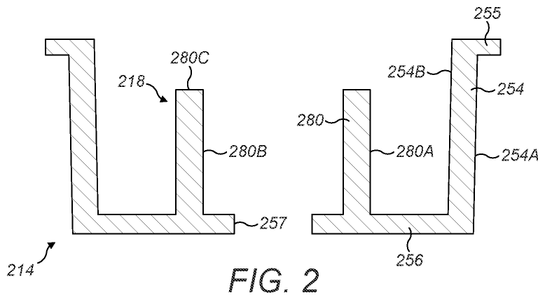

FIG. 2 is an enlarged view of a first piston of the apparatus of FIG. 1;

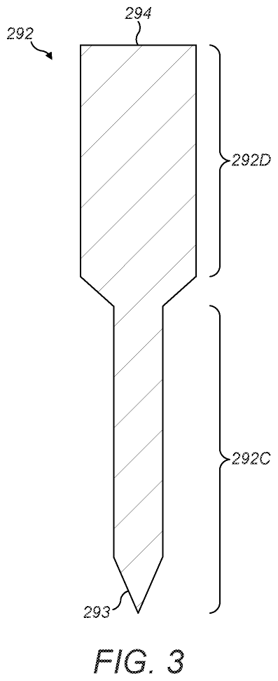

FIG. 3 is an enlarged view of a valve element of the apparatus of FIG. 1;

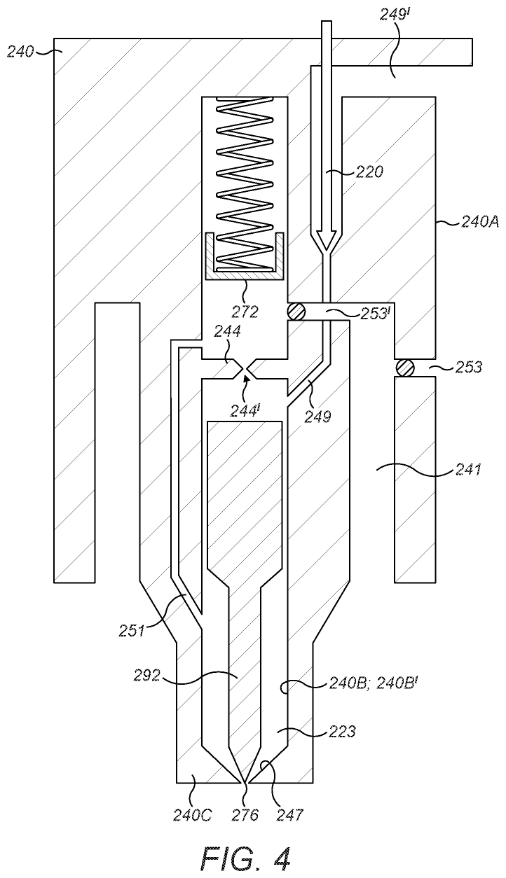

FIG. 4 is an enlarged view of a first part of the body of the injector apparatus of FIG. 1, showing the valve element in a bore of the first part;

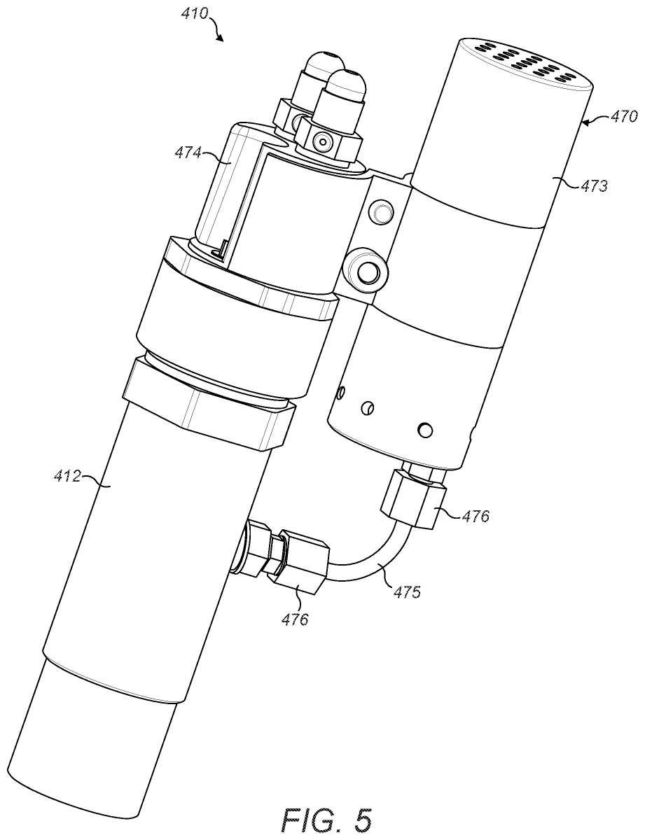

FIG. 5 is a perspective view of a second embodiment of injector apparatus according to the present invention.

With reference to FIGS. 1 to 5 there is shown an injector apparatus 210 having a body 212, a first piston 214, an injector nozzle 216, and a second piston 218.

The injector apparatus further includes a control chamber vent valve 220.

In use, the injector apparatus is attached to a cylinder head 230 (shown schematically) or the like with the nozzle being configured to inject fluid into an associated chamber 232, such as an internal combustion chamber. The associated chamber 232 varies in volume as a piston 234 reciprocates within a cylinder 236 of an internal combustion engine 238.

In use, a pump 228 may be connected to a tank T. The tank T may supply fluid to the pump 228 and may also receive fluid from the injector apparatus as will be further described below.

The body 212 has a first part 240 and a second part 242. The second part 242 is secured to the first part 240 (details of which are not shown).

The second part 242 includes a bore 246 having an internal diameter D, in one example D=25 mm. The second part 242 has a shoulder 248.

The first part 240 includes a line 250 (shown schematically) associated with a pressure relief valve 226 on a return line 252 and with the pump 228.

As best seen in FIG. 2, the first piston 214 has a piston wall 254 sized so that its outer surface 254A is a close sliding fit within bore 246 of the second part 242 so as to essentially seal the wall 254 with the bore 246. Thus, the outer surface 254A has an external diameter which is substantially the same as the internal diameter D of the bore 246. The first piston 214 includes a shoulder 255 and an end wall 256 having a bore 257 through which the end wall 240C of the first part 240 extends. The first piston 214 is slidable within the bore 246 and its lowermost position is defined by engagement of shoulder 255 with the shoulder 248 on the second part 242.

Unitarily formed with the first piston 214 is the second piston 218, or high pressure piston 218. High pressure piston 218 depends upwardly from end wall 256 of the first piston 214 and is cylindrical having a stem 280 with an outer surface 280A, an inner surface 280B and an end surface 280C. End surface 280C is annular and defines the high pressure working area, as will be further described below.

As best seen in FIG. 3, a valve element 292 is generally elongate and includes a first end 292C and a second end 292D. The diameter of the first end 292C is smaller than the diameter of the second end 292D. First end 292C defines a valve surface 293 selectively engageable with and selectively disengageable from the valve seat 247, as will be further described below. Second end 292D defines a second end surface 294 and is received in a bore 240B′ defined by inner surface 240B. The sizing of the second end 292D and bore 240B′ is such that the second end 292D of the valve element 292 is a close sliding fit within the bore 240B′ so as to essentially seal the second end 292D with the bore 240B′ defined by inner surface 240B. The close sliding fit allows the valve element 292 to slide axially relative to the bore 240B′. The valve member 292 is biased towards a closed position, in which the valve surface 293 is engaged with the valve seat 247, by a spring (not shown).

As best seen in FIG. 4, the first part 240 includes a passage 249 associated with the control chamber vent valve 220. First part 240 is generally elongate and includes an outer surface 240A, an inner surface 240B and an end wall 240C defining a valve seat 247 of the injector nozzle. The injector nozzle 216 has one or more orifices 276 formed in the end wall. The first end 292C of the valve element 292 is sized so as to create a clearance between the outer surface of first end 292C and the inner surface 280B of the first part 240 thereby forming an annular nozzle chamber 223 below the second end 292D, above the valve seat 247 and around the first end 292C. Second end 292D is positioned part way along bore 240B′. A restrictor 244 extends across the bore 240′ above the second end 292D. A control chamber 215 is defined by the region of the bore 240B′ above the second end 292D and below the restrictor 244.

The injector apparatus further includes an accumulator 270 comprising an accumulator chamber 271 which is defined by the region of the bore 240B′ which is above the restrictor 244. The restrictor 244 includes a restriction orifice 244′ by which the control chamber 215 and the accumulator chamber 271 are fluidly coupled. The restrictor 244 thus forms a partial barrier between the control chamber 215 and the accumulator chamber 271. The accumulator chamber 271 is fluidly coupled to the nozzle chamber 223 by a passage 251 which bypasses the control chamber 215. This allows fluid from the accumulator chamber 271 to pass around the second end 292D of the valve element 292 to the nozzle chamber 223 and through injector orifices 276 and into the combustion chamber or the like, as will be further described below. The accumulator chamber 271 has an end wall 272 opposite the restrictor 244. The wall may comprise a flexible diaphragm or may be sprung (as shown in FIGS. 1 and 4). This allows the volume of the accumulator chamber 271 to change and provides a compressive force to fluid stored in the accumulation chamber. Alternatively, the accumulator chamber may comprise a simple, rigid-walled volume which is charged using the elasticity of fluid stored in the accumulator chamber 271. This is possible due to the relatively high compressibility of the fluid, such as diesel fuel, at the high fluid pressures generated during operation of the injector 210.

The stem 280 of the high pressure piston 218 is slidable within an annular bore 241 of the first part 240. The stem 280 is sized so that the outer surface 280A and inner surface 280B of the stem 280 form a close sliding fit within the annular bore 241 so as to essentially seal the stem 280 with the annular bore 241. The annular end surface 280C of the first piston 214 and the annular bore 241 together define a high pressure chamber 219. The close sliding fit between the stem 280 and the side walls of the bore 241 allows the high pressure piston 218 to slide axially relative to the first part 240 to vary the volume of the high pressure chamber 219. The high pressure chamber 219 is fluidly connected to the accumulator chamber 271 by a refill port in the form of a passage 253′ including a check valve 224. The check valve 224 is configured to allow fluid to flow from the high pressure chamber 219 into the accumulator chamber along passage 253′ and to substantially prevent fluid from flowing in the opposite direction. Although only a single check valve 224 is illustrated in FIGS. 1 and 4, the injector apparatus could have any suitable number of check valves between the high pressure chamber 219 and the accumulator chamber 271. For example, the injector apparatus could have two, three, four or five check valves between the high pressure chamber 219 and the accumulator chamber 271.

The first piston 214 defines an annular region 260 between the inner surface 254B of the piston wall 254 and the outer surface 280A of the stem 280. The first part 240 and second part 242 of the body define an annular region 261 between the outer surface 240A of the first part 240 and the inner surface of the second part 242 which surrounds the first part 240. Region 261 is fluidly connected to region 260. Together region 260 and region 261 form a low pressure chamber 222.

The control chamber 215 is generally cylindrical and is defined by the region of inner surface 240B between the end surface 294 of second end 292D and the restrictor 244. The control chamber 215 is fluidly connected to the control volume vent valve 220 by a passage 249 in a wall of the control chamber which extends through the first part 240 from the inner surface 240B to the control chamber vent valve 220. Passage 249 bypasses the high pressure chamber 219. The opposite side of the control chamber vent valve 220 is fluidly connected to the low pressure chamber 222 by a passage 249′. The control chamber vent valve 220 may be operated by a solenoid (not shown). When the control chamber vent valve 220 is open, the control chamber 215 is connected to the low pressure chamber 222 via passages 249 and 249′. When the control chamber vent valve 220 is closed, passage 249 is isolated from passage 249′ and fluid communication between the control chamber 215 and the low pressure chamber 222 is prevented.

The low pressure chamber 222 is generally annular and is fluidly connected to pump 228 (shown schematically) via line 250. A return line 252 extends between the line 250 and the tank T from a location downstream of the pump 228. A pressure relief valve (PRV) 226 is provided on the return line 252. When fluid pressure in line 250 is at or below a threshold valve, for example the output pressure from the pump 228, the PRV 226 remains closed and fluid is pumped by the pump 228 along the line 250 towards the low pressure chamber 222. When fluid pressure in line 250 is above the threshold, for example the output pressure from the pump 228, the PRV 226 opens and fluid is vented to tank T along return line 252. The low pressure chamber 222 is fluidly connected to the high pressure chamber 219 by a passage 253 in which a check valve 225 is located. The check valve 225 is configured to allow fluid to flow from the low pressure chamber 222 into the high pressure chamber 219 and to substantially prevent fluid from flowing in the opposite direction.

The accumulator chamber 271 may have a maximum volume of from 2 to 20 times the maximum volume of the nozzle chamber 223. The accumulator chamber 271 may have a maximum volume of from 400 to 4000 times the maximum volume of the control chamber 215. The accumulator chamber 271 may have a maximum volume of from 7 to 700 times the maximum volume of the high pressure chamber 219. For example, the accumulator chamber 271 may have a maximum volume of from 2 to 20 cc. In one particular example, the accumulator chamber has a maximum volume of 7 cc, the control chamber 215 has a maximum volume of 0.005 cc, the high pressure chamber 219 has a maximum volume of 0.3 cc, and the nozzle chamber 223 has a maximum volume of 1 cc.

Operation of the injector apparatus is as follows:

Prior to injection, for example at the start of the compression stroke of the piston 234, the injector apparatus 210 is in the primed condition. In the primed condition, the high pressure chamber 219, accumulator chamber 271, control chamber 215 and nozzle chamber 223 are all primed with fluid supplied from the tank T via pump 228 and line 250. The fluid is at relatively low pressure (e.g. 3-5 bar) and is supplied to the low pressure chamber 222 via line 250 from which it enters the high pressure chamber 219 through check valve 225 and passage 253, enters the accumulator chamber 271 from the high pressure chamber 219 via check valve 224, enters the control chamber 215 from the accumulator chamber 271 via restrictor orifice 244′, and enters the nozzle chamber 223 from the control chamber 215 via passage 251. The first piston 214 is in its lowermost position (as shown in FIG. 1) such that shoulder 255 of the first piston 214 is in engagement with shoulder 248 of the body. The valve element 292 is also in its lowermost position such that valve surface 293 is in engagement with valve seat 247 thereby isolating the orifices 276 from the nozzle chamber 223. Control volume vent valve 220 is closed. PRV 226 is closed. The fluid pressures within the control chamber 215 and the nozzle chamber 223 are equalised by orifice 244′ and passage 251 and so the valve member 292 remains in the closed position and the valve member 292 is engaged with valve seat 247 via valve surface 293.

As the piston 234 ascends within cylinder 236 during the compression stroke of the internal combustion engine 238, pressure is developed within the combustion chamber 232. This increasing pressure (P_{comb}) acts on the working area (A_{fp}) of the first piston 214 to generate a force (F_{fp}) in the direction of arrow A, which can be expressed as:

F_{fp}=P_{comb}×A_{fp}

The first piston working area (A_{fp}) is defined by the area of the end wall 256. Where the first piston 214 is circular, the working area of the first piston 214 is equal to (π/4)D². Thus, as the pressure P_{comb} within the combustion chamber 232 increases, so too does the force F_{fp} on the first piston 214 in the direction of arrow A.

The effective area (Aₕₚ) of the high pressure piston 218, or “high pressure piston working area” is defined by the area of the end surface 280C. Where the end surface 280C of the stem has a circular annular shape, as in this example, then the high pressure piston working area (Aₕₚ) is equal to π/4× (outer surface 280A diameter−inner surface 280B diameter)².

Once the pressure P_{comb} exceeds the supply pressure from the pump 228, and therefore exceeds the pressure Pᵢₚ in the low pressure chamber 222, the first piston 214 begins to move upward, i.e. in the direction of arrow A. This causes the high pressure piston 218 to ascend within the high pressure chamber 219, thereby reducing the volume of the high pressure chamber 219 and increasing the pressure Pₕₚ in the high pressure chamber 219. This closes the check valve 225 between the high pressure chamber 219 and the low pressure chamber 222. Fluid which is displaced from the low pressure chamber 222 by the upward movement of the first piston 214 is vented to tank T via line 250 and the PRV 226.

As will be appreciated, the high pressure piston working area Aₕₚ is significantly smaller than the effective area A_{fp} of the first piston 214, and as such the pressure within the high pressure chamber 219 will be greater than the pressure created in the combustion chamber 232 of the internal combustion engine 238. This allows extremely high injection pressures to be generated, e.g. above 3000 bar. The pressure Pₕₚ in the high pressure chamber 219 is defined by the pressure P_{comp} in the combustion chamber 232 multiplied by the ratio of the working areas of the first piston 214 and the high pressure piston 218, i.e. Rₕₚ=P_{comp}×(A₁/A₂), minus the pressure Pᵢₚ in the low pressure chamber 222.

As the pressure in the high pressure chamber 219 increases, fluid is transferred to the accumulator chamber 271 via check valve 224 thereby charging the accumulator chamber 271. Fluid is also transferred to the control chamber 215 and to the nozzle chamber 223 via restrictor orifice 244′ and passage 251. As in the primed condition, the fluid pressures within the control chamber 215 and the nozzle chamber 223 are equalised through orifice 244′ and passage 251 and so the valve 291 remains closed despite the increase in fluid pressure.

In order to start injection, a control system (not shown) causes the control volume vent valve 220 to open e.g. by powering a solenoid. This fluidly connects passage 249 to passage 249′, and hence fluidly connects the control chamber 215 to the low pressure chamber 222. Thus, the pressure in the control chamber 215 falls as fluid is vented from the control chamber 222 to the low pressure chamber and back to tank T via line 250 and PRV 226.

Due to the presence of restrictor 244 and the small size of the orifice 244′ relative to the bore of passage 249, fluid leaves the control chamber 215 via passage 249 quicker than it can enter the control chamber 215 from the accumulator chamber 271 via orifice 244′. This results in a pressure differential between the control chamber 215 and both the accumulator chamber 271 and the nozzle chamber 223. Thus, as the pressure drops in the control chamber 215, the pressure in the nozzle chamber 223 remains high, thereby causing the valve member 292 to move in the direction of arrow A, i.e. upwardly when viewing FIG. 1, so as to disengage the valve surface 293 from the valve seat 247 and fluidly connect the nozzle chamber 223 with the injector orifices 276. This allows the fluid within the nozzle chamber 223 to be injected through the orifices 276 into the internal combustion chamber, thereby initiating combustion.

As fluid is injected, the first piston 214 progressively moves in the direction of arrow A, i.e. rises when viewing FIG. 1, and continues to compress the high pressure chamber 219 and thereby supply high pressure fluid to the accumulator chamber 271. While the pressure Pₕₚ in the high pressure chamber 219 remains higher than pressure P_{comp} in the control chamber 215, the valve surface 293 of the valve element 292 remains disengaged from the valve seat 247. In this manner, the injector nozzle 216 continues to inject fuel into the combustion chamber while fluid from the control chamber 215 is vented to tank.

In order to stop injection, the control volume vent valve 220 is closed thereby isolating passage 249 from passage 249′ and hence isolating the control chamber 215 from the low pressure chamber 222 and the tank T. Fluid flows from the accumulator chamber 271 to the control chamber 215 via the orifice 244′ to bring the pressure in the control chamber 215 back up to that of the accumulator chamber 271 and the nozzle chamber 223. Once the pressure differential between the control chamber 215 and the nozzle chamber 223 is small enough to be overcome by the spring by which the valve element 292 is biased towards the closed position, the valve element 292 returns to the closed position in which the valve surface 293 engages with the valve seat 247 thereby closing valve 291 and isolating the injector orifices from the high pressure chamber 219 whereupon injection ceases.

Continued upward movement of the first piston 214 further reduces the volume of the high pressure chamber 219 and increases the pressure therein according to the ratio of the high pressure piston working area and the first piston, as discussed above. Provided the fluid pressure in the high pressure chamber 219 exceeds that of the accumulator chamber 271, fluid is transferred to the accumulator chamber 271 from the high pressure chamber 219 via check valves 224 to charge the accumulator.

Note that even once fluid injection is stopped, the chambers downstream of check valve 224, i.e. the accumulator chamber 217, control chamber 215 and nozzle chamber 223, remain pressurised by virtue of check valve 224.

Injection typically occurs towards the end of a compression stroke and/or at the start of a combustion (expansion) stroke. Because these chambers remain pressurised at the end of injection, further injection is possible during the particular compression/combustion stroke by reopening the control chamber vent valve 220. Such “double” injection is referred to as “double strike” injection. As will be appreciated, the present invention allows for two or more distinct injections (i.e. multi-strike injection) to occur during a single compression/combustion stroke.

By providing an accumulator which is operable to supply fluid under pressure through an injector orifice into an associated chamber and configuring the high pressure chamber such that it is operable to pressurise the accumulator with fluid, the present invention allows for two or more distinct injections to occur during a single compression/combustion stroke.

Once injection for a particular compression/combustion stroke has finally stopped, the pressure within the combustion chamber will fall significantly, typically when an exhaust valve or valves are opened, and consequently the pressure within the high pressure chamber 219 will also fall significantly. The pressure within the combustion chamber 232 will remain at a relatively low pressure during an exhaust stroke and during an inlet stroke. At some time during the time period when the pressure in the combustion chamber is relatively low, the injector apparatus will be re-primed with fuel in time for the next injection event which will occur at the next compression/combustion stroke.

In order to re-fill or re-prime the injector apparatus, the pump provides pressurised fluid (e.g. at around 3-5 bar) which flows along line 250 into the low pressure chamber 222 to fill the low pressure chamber 222 and push the first piston 214 to the start position in which the shoulder 255 of the first piston abuts the shoulder 248 on the body 212. This expands the high pressure chamber 219 back to its starting volume and reduces the pressure Pₕₚ therein. Once the pressure Pₕₚ in the high pressure chamber 219 falls below the pressure Pᵢₚ in the low pressure chamber 222, check valve 225 opens and the high pressure chamber 219 is primed with fluid via passage 253.

By providing an accumulator which is pressurised with fluid by the high pressure chamber and is operable to supply fluid under pressure through the injector orifice, the available injection pressure for the next engine cycle is increased. This allows greater flexibility in deciding the optimal injection timing while maintaining maximum potential injection pressure. Without the accumulator, the maximum available injection pressure at any given moment is limited by the pressure P_{comp}×the area ratio between A_{fp} and Aₕₚ. Consequently, if it were desired to inject prior to TDC, when peak cylinder pressure has not yet been reached, the injection pressure would be limited. Similarly, if it were desired to inject late after TDC, when peak cylinder pressure has passed, injection pressure would again be limited. The accumulator provides the freedom to adjust injection timing whilst maintaining an injection pressure which would not otherwise be achievable. The accumulator serves to damp out the highly dynamic changes in fluid pressure that would otherwise be seen in the injector.

Although the high pressure piston 218 is illustrated as being unitary with the first piston 214, this need not necessarily be the case. Instead, the high pressure piston 218 could be positioned elsewhere in the injector apparatus. For example, the control piston could be fixed to the first part 240 of the injector body 212 and moveable within a bore defined in the first piston. Alternatively, the high pressure piston may be remote from the first piston with the first piston being configured to move the high pressure piston directly or indirectly via one or more intermediate components or chambers. One or both of the first piston and the high pressure piston may be aligned with or offset from the central axis of the injector

Although a single high pressure piston is illustrated, the injector apparatus may comprise two or more high pressure pistons.

Further, although the high pressure chamber and the control chamber are illustrated as being re-primed via the low pressure chamber, one or both of the high pressure chamber and control chamber may be in fluid communication with the feed line via one or more passages which bypass the low pressure chamber.

Additionally, while the accumulator is illustrated as comprising a chamber which is defined by the first part of the body of the injector and located directly above the control chamber and valve element, it may be positioned elsewhere within the body. It may also be connected to the control chamber and nozzle chamber by one or more additional passages. For example, the accumulator may be offset from the control chamber in the first part, or may be defined by the second part of the injector body. In other embodiments, the accumulator need not be integral with the injector body but may be provided as an external accumulator which is mounted on or adjacent to the injector body, as discussed below in relation to FIG. 5.

FIG. 5 shows a perspective view of an injector 410 according to a second embodiment of the invention. The injector 410 is similar in structure and operation to the injector 210 of the first embodiment. However, unlike the first embodiment, the accumulator 470 is external to the injector body 412. The accumulator 470 includes one or more accumulator chambers (not shown) defined within an accumulator housing 473 which is mounted on the injector body 412, for example fixed to a top cap 474 of the injector apparatus 410 in which the fuel fittings and electrical connections are provided. The one or more accumulator chambers are fluidly connected to the high pressure chamber by an external hose 475 which is sealed against the accumulator housing and the injector body 412 by hose connectors 476. The accumulator 470 may be fluidly connected to the nozzle chamber of the injector 410 via a passage (not shown) which is either within the hose 475 or provided in an additional hose. Alternatively, or in addition, the accumulator may be fluidly connected to the nozzle chamber of one or more further injectors. In this manner, where the internal combustion engine comprises multiple cylinders, each with one or more injectors, the pressure within the associated cylinder of a first injector may be used to pressurise the nozzle chamber of a second injector. This may be advantageous in terms of injection timing relative to the position of the piston of the associated chamber. Further, the accumulator 470 may be shared by two or more injectors of multiple cylinders of the engine. For example, the accumulator 470 may be a single common accumulator which is shared by all of the injectors of the internal combustion engine.

1. An injector apparatus for injecting fluid under pressure into an associated chamber, the apparatus including:
a body,
a first piston moveable in the body, the first piston defining a first working area facing an associated chamber,
a high pressure piston defining a high pressure working area facing a high pressure chamber,
the first working area being greater than the high pressure working area, the first piston being operable to compress fluid in the high pressure chamber using the high pressure piston,
the injector apparatus further including an accumulator,
the high pressure chamber being operable to pressurise the accumulator with fluid and the accumulator being operable to supply fluid under pressure through an injector orifice into an associated chamber.

2. The injector apparatus of claim 1, wherein the injector apparatus further comprises one or more check valves located between the accumulator and the high pressure chamber.

3. The injector apparatus of claim 2, wherein the one or more check valves are configured to allow fluid flow in a first direction from the high pressure chamber to the accumulator and to restrict or prevent fluid flow in a second direction from the accumulator to the high pressure chamber.

4. The injector apparatus of claim 1,
wherein the accumulator is located downstream of the high pressure chamber and upstream of the injector orifice.

5. The injector apparatus of claim 1, further comprising a refill port by which the high pressure chamber is refilled with fluid during operation, wherein the accumulator is located downstream of the refill port and upstream of the injector orifice.

6. The injector apparatus of claim 1, wherein the accumulator has a maximum volume of from 7 to 700 times the maximum volume of the high pressure chamber.

7. The injector apparatus of claim 1, wherein the accumulator has a maximum volume of from 2 to 20 cc.

8. The injector apparatus of claim 1, wherein the volume of the accumulator is constant.

9. The injector apparatus of claim 1, further comprising a control chamber, wherein movement of the first piston is selectively controllable by controlling the fluid in the control chamber, and wherein the accumulator has a maximum volume of from 400 to 4000 times the maximum volume of the control chamber.

10. The injector apparatus of claim 9, further comprising a valve seat and a valve member selectively operable to engage the valve seat to operably isolate the high pressure chamber from the injector orifice and selectively operable to disengage the valve seat to fluidly connect the high pressure chamber with the injector orifice.

11. The injector apparatus of claim 10 wherein the control chamber is partially defined by the valve member.

12. The injector apparatus of claim 10, further including a control chamber vent valve operable to vent the control chamber to a low pressure region to allow the valve member to disengage the valve seat.

13. (canceled)

14. (canceled)

15. The injector apparatus of claim 14 further comprising a restrictor having a restrictor orifice by which the control chamber is fluidly coupled with the accumulator.

16. The injector apparatus of claim 15, further including a control chamber vent valve operable to vent the control chamber to a low pressure region, wherein the restrictor orifice is configured to generate a pressure differential between the control chamber and the accumulator when the control chamber vent valve is operated to vent the control chamber to a low pressure region.

17. (canceled)

18. The injector apparatus of claim 1, further comprising a nozzle chamber directly upstream of the injector orifice, wherein the accumulator is operable to supply fluid under pressure through the injector orifice via the nozzle chamber, and wherein the accumulator has a maximum volume of from 2 to 20 times the maximum volume of the nozzle chamber.

19. (canceled)

20. The injector apparatus of claim 1, wherein the accumulator comprises an accumulator chamber defined within the body of the injector.

21. The injector apparatus of claim 20, wherein the accumulator chamber is concentric with the injector orifice.

22. The injector apparatus of claim 1, wherein the accumulator is external to the body of the injector, and wherein the accumulator is operable to supply fluid under pressure through the injector orifice of the injector apparatus into an associated chamber of the injector apparatus.

23. (canceled)

24. The injector apparatus of claim 22, wherein the accumulator is operable to supply fluid under pressure through an injector orifice of a further injector apparatus into an associated chamber of the further injector apparatus.

25-29. (canceled)

30. The injector apparatus as defined claim 1, wherein the injector apparatus further includes a low pressure chamber at least partially defined by the first piston and a bore of the body and configured to displace fluid to a low pressure region during injection, and wherein the control chamber is fluidly connected to the low pressure chamber via a first passage in which a control chamber vent valve is located, the control chamber vent valve being operable to vent the control chamber to the low pressure chamber.

31. (canceled)

32. The injector apparatus as defined in claim 30, wherein the high pressure chamber is fluidly connected to the low pressure chamber via a second passage in which an inlet check valve is located, the inlet check valve being configured to permit the supply of fluid to the high pressure chamber from the low pressure chamber via the second passage.

33. The injector apparatus as defined in claim 30, wherein the low pressure chamber is at least partly defined by an annular bore of the first piston.

34. The injector apparatus as defined in any preceding claim, further comprising a pump operable to supply fluid to the high pressure chamber along a feed line, and a pressure relief valve between the feed line and a low pressure region, wherein the pressure relief valve is configured to close when the fluid pressure in the feed line is at or below a threshold value and to open to vent fluid from the feed line to the low pressure region when the fluid pressure in the feed line exceeds the threshold value.

35. (canceled)

36. An injector system comprising:
a first injector apparatus for injecting fluid under pressure into an associated chamber; and
a second injector apparatus for injecting fluid under pressure into an associated chamber,
wherein each injector apparatus comprises:
a body;
a first piston moveable in the body, the first piston defining a first working area facing an associated chamber;
a high pressure piston defining a high pressure working area facing a high pressure chamber, the first working area being greater than the high pressure working area, the first piston being operable to compress fluid in the high pressure chamber using the high pressure piston; and
an injector orifice,
wherein the injector system further comprises an accumulator which is common to both of the first and second injector apparatuses, the high pressure chamber of each of first and second injector apparatuses being operable to pressurise the accumulator with fluid, and
wherein the accumulator is operable to supply fluid under pressure through the injector orifice of the first injector apparatus and through the injector orifice of the second injector apparatus.

37. A reciprocating internal combustion engine comprising at least one combustion chamber, and at least one injector apparatus according to claim 1, the at least one injector apparatus being configured to inject fluid under pressure into the at least one combustion chamber.
